(19) United States
(12) Patent Application Publication
(10) Pub. No.: US 2026/0188317 A1
(43) Pub. Date: Jul. 2, 2026

(54) SYSTEM AND METHOD FOR IMPLEMENTING LOCAL VOICE CONTROL OF AN ELECTRONIC DEVICE

(71) Applicant: IAI Smart Inc., Whippany, NJ (US)

(72) Inventor: Jun (Jason) Jiang, Short Hills, NJ (US)

(73) Assignee: IAI Smart Inc., Whippany, NJ (US)

(21) Appl. No.: 19/430,209

(22) Filed: Dec. 22, 2025

Related U.S. Application Data
(60) Provisional application No. 63/741,159, filed on Jan. 2, 2025.

(51) Int. Cl. G10L 15/22; A47J 36/32; A47J 37/06; G10L 15/06; G10L 15/08; H04R 1/02

(52) U.S. Cl. CPC G10L 15/22; A47J 36/32; A47J 37/0641; G10L 15/063; G10L 15/08; G10L 2015/088; G10L 2015/223; G10L 2015/225; H04R 1/028

(57) ABSTRACT

Disclosed herewith is a method and apparatus that can be controlled by a voice input without a network connection. The apparatus may be an air fryer that includes an internal cavity within a body of the air fryer, a heating element configured to generate heat within the internal cavity, a perforated frame configured to fit within the cavity and configured to support a food product, a fan configured to move heat from the heating element toward the food product, a microphone for receiving a voice input, a voice processing module configured to determine a command for controlling the air fryer based on the voice input, the voice processing module including a localized module that processes the voice input locally, and a memory storing a plurality of commands for controlling the apparatus.

### CROSS REFERENCE TO RELATED APPLICATIONS

This application claims priority to U.S. Provisional Application No. 63/741,159, filed on Jan. 2, 2025, the entire contents of which are incorporated herein by reference.

### FIELD OF INVENTION

The present disclosure generally relates to methods and systems for implementing local voice control of one or more electronic devices of the same or different types and, more specifically, methods and systems for implementing voice control of one or more electronic devices without the need to connect to a network.

### BACKGROUND OF THE DISCLOSURE

Voice-controlled systems have been incorporated into various electronic devices; however, many commonly used consumer products—such as household appliances, including kitchen appliances such as air fryers, thermostats, and basic home electronics—still lack this voice-control functionality. As a result, users are often required to rely on other interaction methods, such as buttons, touchscreens, gestures, or manual controls. These approaches can be cumbersome and less efficient, particularly for users with mobility or visual impairments.

Integrating voice control functions into these devices could significantly improve their usability, making them more intuitive and convenient for users. However, many existing voice-controlled systems are reliant on cloud-based processing, which introduces a range of challenges that degrade the user experience, including the sluggishness of responses and privacy concerns.

For example, cloud-dependent systems generally require an active internet connection to process voice commands, leading to delays, slower response times, and an overall less responsive experience.

As another example, typical smart air fryers equipped with voice control generally depend on cloud-based platforms like Amazon® Alexa® or Google® Assistant. While these systems can offer enhanced functionality, they introduce several drawbacks. Reliance on cloud connectivity can result in latency and inconsistent performance, especially in environments with unstable internet access. Furthermore, cloud integration raises significant privacy concerns, as user interactions may be stored or transmitted to external servers, raising the risk of unauthorized access, data breaches, and misuse of personal information. Such concerns are particularly important in environments where privacy is critical, leading to hesitancy among users who prioritize confidentiality and security. The need to maintain constant wireless connectivity also increases standby power consumption, leading to reduced energy efficiency. Additionally, these devices often require complex initial setup procedures, including mobile app installation, Wi-Fi configuration, and user account registration-barriers that can be particularly problematic for elderly users or those unfamiliar with modern digital interfaces.

In contrast, non-voice enabled and/or offline air fryers that operate without cloud dependency provide improved energy efficiency and enhanced user privacy. However, they tend to lack advanced features such as voice control, remote operation, and preset cooking programs. Users must remain physically present to operate the appliance, manually adjusting time and temperature settings for each use. These limitations reduce the practicality and accessibility of the device, particularly for individuals seeking hands-free or automated operation.

Accordingly, there is a need for an electronic system, such as an air fryer system, that integrates both offline and/or cloud-based voice control capabilities. Such a system would preserve the privacy and low-power benefits of local processing while offering the advanced features and flexibility associated with intelligent, voice-activated appliances, delivering a more accessible, user-friendly, and energy-conscious solution.

Additionally, there is a need for electronic devices, including household appliances, with improved voice-controlling functions that do not rely on cloud-based systems to operate.

### SUMMARY OF THE DISCLOSURE

The present disclosure addresses shortcomings of conventional controlling methods by providing a localized voice controlling function. The localized voice controlling function includes a localized voice processing module contained within the device itself, which does not require a network connection to process voice input. By processing voice commands locally, the system and method as provided in the present disclosure can result in faster response time, greater privacy, and continued functionality even when offline. As used herein, the term “offline,” “locally,” or lack of connectivity or no connectivity may generally refer to the state of being disconnected from and/or being unable to make a connection to an authentication service, a network, and/or any other network-based resource. For example, an apparatus can be considered offline if the apparatus lacks the capability, either via hardware or software, to communicate with a network.

The localized voice processing module includes a learning module capable of learning voice input and/or mapping voice input to controlling commands for a device. The learning module includes a localized language model which has been trained before the installation. The localized language model is configured to recognize voice input without a network connection. By integrating the learning capability on a device, it can expand voice control capabilities to a wider range of devices, improving their usability and convenience.

In an embodiment of the disclosure, a local voice learning and control system for household electronics, such as air fryers, plugs, fans, heaters, vacuums, microwaves and other electronics, which may be operated entirely on-device by processing all voice data locally, is disclosed. This approach can enhance privacy, can reduce latency, and enables offline functionality. An embodiment of the system leverages the device's internal hardware to detect wake words, customize learning modes, and interpret voice commands.

The system and method of the present disclosure can be implemented to a wide variety of products, ranging from relatively simple devices like smart plugs and thermostats to more relatively complex appliances such as air fryers and ovens. Features of the disclosed system include local voice control and recognition, natural language processing, on-device learning, customizable wake words, and efficient voice-to-output database matching, all aimed at improving user experience and functionality.

The present disclosure includes a system for controlling an electronic device with a voice input comprising: a microphone for receiving a voice input; a voice processing module configured to determine a command for controlling the electronic device based on the voice input, the voice processing module including a localized module that processes the voice input locally; and a memory storing a plurality of commands for controlling the electronic device.

The present disclosure includes an air fryer apparatus configured for cooking food, the air fryer apparatus comprising: an internal cavity within a body of the air fryer apparatus; a heating element configured to generate heat within the internal cavity; a perforated frame configured to fit within the internal cavity and configured to support a food product; a fan configured to move heat from the heating element toward the food product; a microphone for receiving a voice input; a voice processing module configured to determine a command for controlling the air fryer apparatus based on the voice input, the voice processing module including a localized module that processes the voice input locally; and a memory storing a plurality of commands for controlling the air fryer apparatus.

The present disclosure includes a hardware processor for an apparatus comprising: a central processing unit configured to receive a first input from a user; an audio input processor configured to receive a second input, wherein the second input is a voice input, the audio input processor further configured to process the second input locally, and transmit the processed second input to a command detection processor; the command detection processor to locally identify a command from the processed second input; and a learning module configured to locally learn voice inputs of different users.

A method of controlling an apparatus, the method comprising: receiving an acoustic input via a microphone; transmitting the acoustic input to an acoustic input processor configured to locally determine a command for controlling the apparatus based on the acoustic input; storing a plurality of commands for controlling the apparatus; determining the command from the plurality of commands; and locally learning acoustic inputs of different users.

### BRIEF DESCRIPTION OF THE DRAWINGS

The accompanying drawings, which are incorporated in and constitute a part of this specification, illustrate embodiments of the disclosure, and, together with the summary given above, and the detailed description of the embodiments below, serve as a further explanation and disclosure to explain and/or illustrate embodiments of the disclosure.

FIG. 1A is an air fryer apparatus with voice control functions, according to an embodiment;

FIG. 1B is a cross-sectional view of an air fryer apparatus with voice control functions, according to an embodiment;

FIG. 2 is an electrical plug with voice control functions, according to an embodiment;

FIG. 3 is an illustration of device operating modes, according to an embodiment;

FIG. 4 is an illustration of device learning modes, according to an embodiment;

FIG. 5 is a functional block diagram of an offline voice-control architecture, according to an embodiment;

FIG. 6 is a flow chart illustrating a method of learning, according to an embodiment;

FIG. 7 is an embodiment of an offline voice-control architecture, according to an embodiment;

FIG. 8 is an embodiment of an offline voice-control architecture, according to an embodiment; and

FIG. 9 is an embodiment of an offline voice-control system architecture for a plug, according to an embodiment.

### DETAILED DESCRIPTION OF THE DISCLOSURE

It is noted that the drawings of the present application are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present application. However, it will be appreciated by one of ordinary skill in the art that various embodiments of the present application may be practiced without these specific details. In other instances, well-known structures or processing steps have not been described in detail in order to avoid obscuring the present application.

As used herein, the term “substantially” or “substantial”, is equally applicable when used in a negative connotation to refer to the complete or near complete lack of an action, characteristic, property, state, structure, item, or result. For example, a surface that is “substantially” flat would either be completely flat, or so nearly flat that the effect would be the same as if it were completely flat.

As used herein, terms defined in the singular are intended to include those terms defined in the plural and vice versa.

As used in this specification and its appended claims, terms such as “a”, “an” and “the” are not intended to refer to only a singular entity but include the general class of which a specific example may be used for illustration, unless the context dictates otherwise. The terminology herein is used to describe specific embodiments of the disclosure, but their usage does not delimit the disclosure, except as outlined in the claims.

Unless otherwise indicated, all numbers expressing quantities of ingredients, properties such as molecular weights, reaction conditions, and so forth as used in the specification and claims are to be understood as being modified in all instances by the term “about.” Accordingly, unless indicated to the contrary, the numerical parameters in the specification and claims are approximations that may vary depending upon the desired properties sought to be obtained by the present disclosure. At the very least, and without limiting the application of the doctrine of equivalents to the scope of the claims, each numerical parameter should at least be construed in light of the number of reported significant digits and by applying ordinary rounding techniques. Notwithstanding that the numerical ranges and parameters describing the broad scope of the disclosure are approximations, the numerical values in the specific examples are reported as precisely as possible. Any numerical value, however, inherently contains standard deviations that necessarily result from the errors found in the numerical value's testing measurements.

Thus, reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc. In yet another illustration, reference herein to a range of from “5 to 10” includes whole numbers of 5, 6, 7, 8, 9, and 10, and fractional numbers 5.1, 5.2, 5.3, 5,4, 5,5, 5.6, 5.7, 5.8, 5.9, etc.

In the discussion and claims herein, the term “about” indicates that the value listed may be somewhat altered, as long as the alteration does not result in nonconformance of the process or structure to the illustrated embodiment. For example, for some elements the term “about” can refer to a variation of 0.1%, for other elements, the term “about” can refer to a variation of ±1% or ±10%, or any point therein.

Reference now will be made in detail to embodiments of the disclosure. It will be apparent to those skilled in the art that various modifications and variations can be made in the present disclosure without departing from the scope or spirit of the disclosure. For instance, features illustrated or described as part of one embodiment can be used on another embodiment to yield a still further embodiment. As another example, features of each embodiment translate to the other embodiments, with combinations of embodiments and the descriptions thereof, within the skill of the art, included in this disclosure.

The present application relates to a local voice learning and control system for electronic devices, allowing users to interact with their devices using voice commands without a network connection. The system and method as provided in the present application are suitable for fully on-device voice recognition and offer the benefits of enhanced privacy, reduced latency, and offline functionality. All voice data processing, including wake word detection and command interpretation, which are discussed further herein, occurs on the device itself. This approach minimizes or excludes reliance on external servers, thereby improving response times and ensuring that sensitive data remains locally stored, so no information leaves that device. The system can be incorporated into a variety of products, including devices such as smart plugs, thermostats, and clocks, as well as other appliances such as air fryers, ovens, heaters, and other suitable electronics and appliances. By enabling interaction through voice commands, the system improves ease of use and accessibility for consumers.

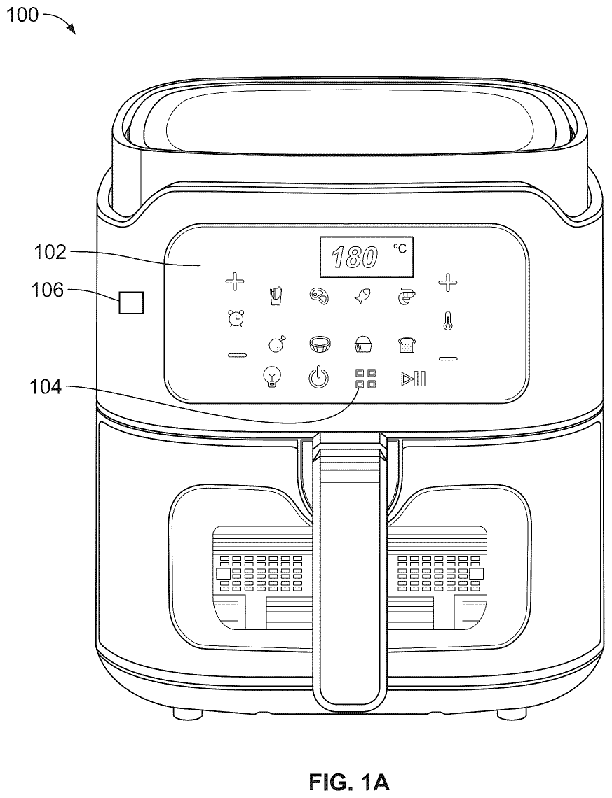

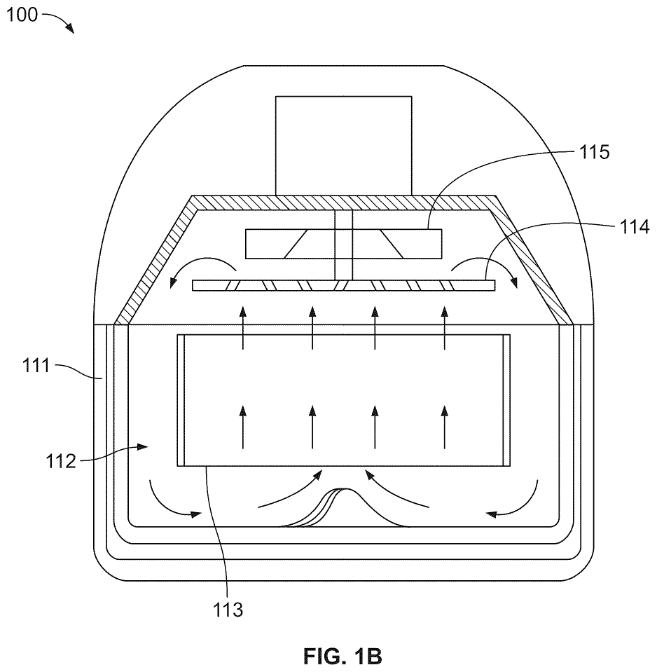

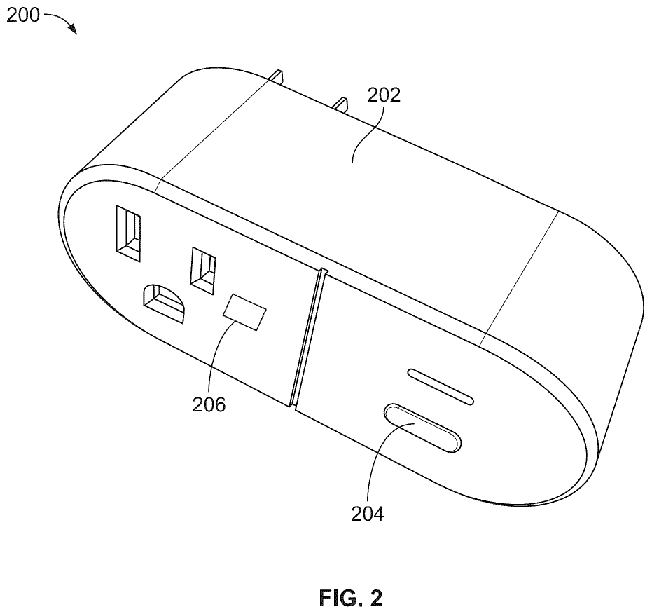

Referring to FIG. 1A, an air fryer apparatus 100 is shown, however, the present disclosure can be directed to any suitable consumer electronic device that can receive voice commands. A cross-sectional view of the air fryer apparatus 100 is shown in FIG. 1B. The air fryer apparatus 100 can include a body 111, an internal cavity 112, a perforated frame 113, and a heating element 114, The internal cavity 112 is configured to house the perforated frame 113, such as an internal frying basket, for the placement of an uncooked food product (or any item a user intends to increase the temperature thereof). The heating element 114 generates heat in the vicinity of the frying basket 113, such as above the frying basket 113. The fan 115 is configured to generate an airflow from the heating element 114 toward the perforated frame 113 to heat the uncooked food product placed in/on the internal frying basket 113. When the air fryer apparatus 100 is operated to air fry food, first uncooked food is placed in/on the perforated frame 113, the heating element 114 is activated to heat up the air within the cavity 112 that surrounds the food, such that the fan 115 will blow and circulate the hot air to the frying basket 113 and increase the air temperature within the cavity 112. Different cooking arrangements can be accomplished by the air fryer apparatus 100, such as different cooking temperatures, different fan speeds and different cooking times. Other embodiments may vary in the quantity and/or position of heating elements and/or fans.

The air fryer apparatus 100 includes an acoustic input unit, such as a microphone 102 and a button 104. The microphone 102 can be any suitable device that can receive sound waves and convert those sound waves into electrical signals, such as digital microphones and analog microphones, that are transmitted to an internal voice processing module 106, discussed further herein. As used herein the term “button” refers to not only depressible switches but also multi-directional toggles, lever switches, triggers, pressure sensors, linear force transducers, torsion sensors, capacitive touch sensors or the like, as well as a display, or portion thereof, that when actuated (e.g., pressed or contacted) can transmit a signal to the internal voice processing module 106. Button 104 receives an input from a user and upon reception of that input, the air fryer apparatus 100 changes states from an idle state to an awake mode that can receive a command phrase directed to operation of the air fryer apparatus 100, such as “heat to 350° for 20 minutes.” In an embodiment, the button 104 may also be configured to activate an identification function which allows a user to name or identify the air fryer apparatus 100 with a unique identifier. For example, when the button 104 is pushed once or continuously, the air fryer apparatus 100 may prompt a user to speak the name of the air fryer apparatus 100 for identification purposes.

As used hereinafter, including the claims, the term “unit,” “engine,” “module,” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. In an embodiment, such components may be combined, as in a printed circuit board assembly.

The internal voice processing module 106 is configured to process the signals provided by the microphone 102 and generate another signal for controlling the operations of the air fryer 100. In an embodiment, the internal voice processing module 106 is configured to simplify the operation of air fryer apparatus' by enabling users to modify cooking settings, such as temperature, duration, and mode, through natural language commands. Commands such as “Set the air fryer to 400 degrees for 20 minutes” or more contextual commands like “Cook 10 chicken nuggets” or “cook 2 slices of frozen pizza” are processed locally and translated into the appropriate temperature, cooking time, and preset mode for the air fryer apparatus 100. The internal voice processing module 106 can then communicate these settings to the air fryer apparatus 100 control elements to ensure the user's preferences are met. By reducing the need for manual navigation through traditional button-based interfaces, the internal voice processing module 106 streamlines and enhances the cooking process.

As another example of an apparatus that can receive voice commands, a plug apparatus 200 is shown in FIG. 2. The plug apparatus 200 includes a microphone 202, a button 204, and an internal voice processing module 206. The plug apparatus 200 is a device that allows users to control the power supplied to electronic devices connected through an outlet of the plug apparatus 200. Button 204 receives an input from a user and upon reception of that input, the plug apparatus 200 changes states from an idle state to an awake mode that can receive a command phrase directed to operation of the plug apparatus 200, such as “turn off in 20 minutes.”

The local internal voice processing module 206 integrates directly with the smart plug apparatus' 200 operation, enabling users to issue commands such as “Turn on” or “Turn off” Upon detecting and processing the user's voice command locally, the plug apparatus 200 can execute the corresponding action, providing a hands-free and convenient alternative to traditional plugs. Furthermore, the internal voice processing module 206 allows users to rename the plug apparatus 200 by holding a designated button 204, prompting the user to provide a new name, which is stored locally by voice processing module 206 and used to identify the device during future interactions.

In another embodiment, the voice processing module may be applied to thermostats that monitor and adjust room conditions based on user input. With the local voice processing module users may issue commands such as “Set the temperature to 72 degrees”, or speak naturally like “I am a little cold now, can you turn heat on to 72 degrees, one second, actually can you turn to 75 degrees for one hour then move back to 72 degrees” or “Go into eco-friendly mode” to adjust temperature, fan speed, operating modes, and/or other settings. These commands are processed locally on the thermostat, and the necessary adjustments are executed accordingly. This functionality allows users to seamlessly manage and control their home environment through simple voice commands without reliance on external servers or cloud-based processing.

The voice processing module may also be included in clocks, enabling users to set alarms, check the time, or adjust various settings using voice commands. Common commands such as “What time is it?” or “Set an alarm for 7 AM” or “Set alarm for 7 AM, then snooze for 15 minutes, then wake me up loud” are processed by the local speech recognition system. Beyond basic operations, the system allows for specific and dynamic voice inputs. For instance, commands like “Turn off the alarm in 15 minutes” or “Snooze the alarm for 10 minutes” are detected and executed locally. By eliminating the need for internet connectivity, the system ensures faster and more reliable control of clock settings and provides uninterrupted functionality even during internet outages.

In an example, the voice processing module operates using local speech recognition and natural language processing technology to interpret and process user-issued utterances. These utterances can be analyzed to identify the user's intent, and additional information provided which may be relevant. The on-device voice processing module can map non-exact or approximate phrases to desired device behavior. The behaviors are stored by the voice processing module and defined locally by the voice processing module as a sequence of discrete actions, such that the behavior desired by the user can be recognized and performed without a transmission delay. This architecture ensures that the voice processing module can process voice commands accurately while allowing users to issue commands in natural language. It is understood by a person of ordinary skill in the art that the natural language processing and the lookup table/database are optional and may be replaced or supplemented by other processing or mapping algorithms.

In an embodiment of the present disclosure, the voice processing module is configured to provide feedback to the user through visual or auditory mechanisms when a user's voice input is processed. Visual feedback may be provided using physical components such as LED indicators, which communicate the device's status with a particular color, brightness, or visual pattern. For example, on a smart plug with voice technology the indicator light will flash quickly upon processing a command. As another example, a smart plug might have an LED indicator which changes from yellow to blue when the device is in the Awake mode. Auditory feedback may also be used to acknowledge receipt of the command, confirm an executed action, or provide an error notification. Such feedback mechanisms ensure that the user is consistently informed of the system's operational status and the outcome of their issued commands.

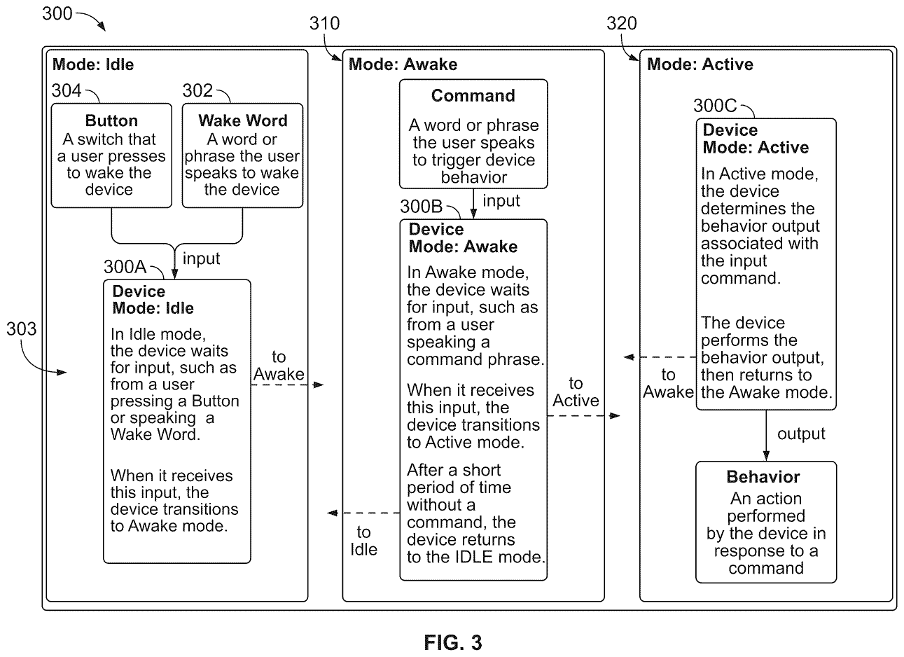

In an embodiment of the present disclosure, the device, for example apparatus 100 and/or apparatus 200 and/or apparatus 300 (which can be any suitable consumer electronic that can receive voice commands) includes a plurality of operating modes, such as an Idle mode 303, an Awake mode 310, and an Active mode 320, illustrated in FIG. 3, which are all controlled by the internal voice processing module. At any time, the apparatus 300 is in one of these three states. The apparatus switches between these modes sequentially, for example, from Idle mode 303 to Awake mode 310, then to Active mode 320, followed by back to Awake mode 310.

Apparatus 300 provides several advantages over systems that rely on cloud-based processing. Enhanced privacy is achieved as user data is not transmitted to remote servers, eliminating or reducing risks of unauthorized access or misuse of data. Since all voice data is processed locally, user information remains secure on the apparatus 300, with no voice recordings sent over the internet, thereby reducing the risk of data breaches or privacy violations.

In addition, processing voice commands and wake word detection locally significantly reduces latency. Cloud-based systems experience delays due to the time required for data to be transmitted to a server, processed, and returned to the device. In contrast, the present system, illustrated in FIG. 3, operates entirely on-device, providing responses for a faster and more seamless user experience. Furthermore, the system offers offline functionality, an advantage over systems that rely on internet connectivity to access cloud servers for speech recognition and processing. This offline capability allows the system to operate in remote locations or areas with limited or no connectivity.

When the apparatus 300 is operating in idle mode 303, the apparatus 300 is an idle state apparatus 300A. In idle mode 303, the idle state apparatus 300A waits for an input from a button 304 and/or a microphone 302 receiving a wake word. The button 304 operates in the same manner or a similar manner to buttons 104 and 204 discussed herein. Button 304 receives an input from a user and upon reception of that input, the apparatus 300 changes states from Idle mode 303 to Awake mode 310, so that apparatus 300 can then receive a command phrase directed to operation of the apparatus 300 in Active mode 320. Upon reception of the input, the idle state apparatus enters awake mode 310 and becomes awake mode apparatus 300B.

In awake mode 310 the awake mode apparatus 300B waits for input, such as receiving an input from a user speaking a command phrase, such as “set temperature for 375°”. In awake mode 310 the awake mode apparatus 300B can either return to idle mode 303 if after a predetermined period of time a command phrase is not received, or the awake mode apparatus 300B can enter active mode 320 and become active mode apparatus 300C if a command phrase is received within a predetermined period of time.

In active mode 320 the active mode apparatus 300C, together with the internal voice processing module, determines the behavior output associated with the inputted command phrase, and proceeds with that behavior, for example, activating heat elements to achieve the intent of the command phrase “set temperature for 375°”. After the behavior is achieved, for example the food is cooked for the specified time at that temperature, the active mode apparatus 300C can return back to awake mode 310 and become awake mode apparatus 300B.

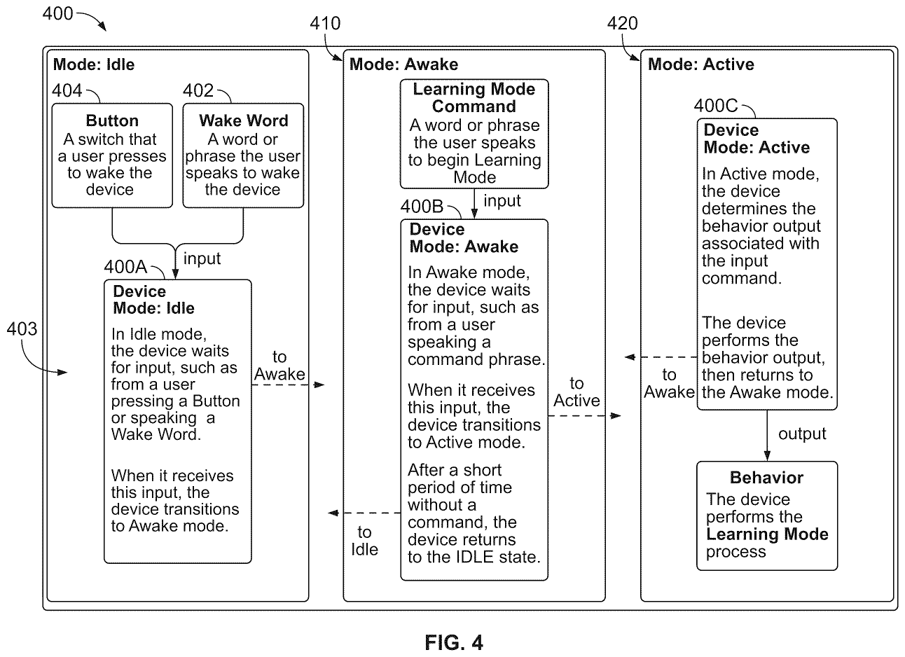

FIG. 4 illustrates an embodiment of the present disclosure, the device, for example apparatus 100 and/or apparatus 200 and/or apparatus 400 (which can be any suitable consumer electronic that can receive voice commands) includes a plurality of operating modes, such as an Idle mode 403, an Awake mode 410, and an Active mode 420, illustrated in FIG. 4, which are all controlled by the internal voice processing module. At any time, the apparatus is in one of these three states.

When the apparatus 400 is operating in idle mode 403, the apparatus 400 is an idle state apparatus 400A. In idle mode 403, the idle state apparatus 400A waits for an input from a button 404 and/or a microphone 402 receiving a wake word. Upon reception of the input, the idle state apparatus enters awake mode 410 and becomes awake mode apparatus 400B.

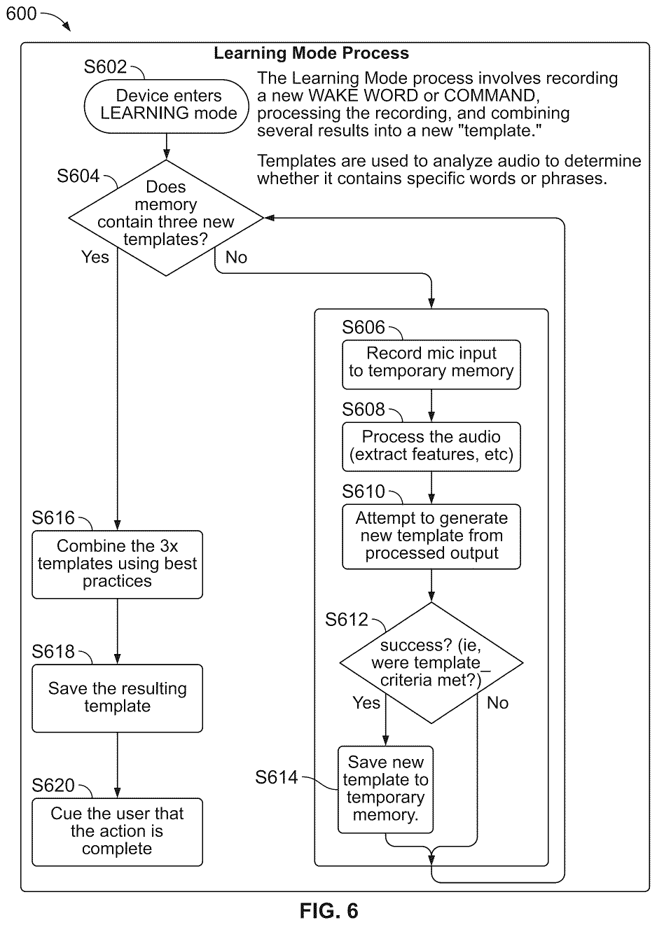

In awake mode 410 the awake mode apparatus 400B waits for input to enter learning mode, such as receiving a voice command or button signal from a user to enter the learning mode. In learning mode the internal voice processing module enters a learning mode and can operate as (or can include a component that operates as) a learning module, which is specified in FIG. 6 and described herein. Learning mode can be applicable to learning voice inputs of one or more users by replacing/changing the wake word, as well as learning behavior based on received prompts, for example, apparatus 100 heating to 375° when receiving the prompt, while in active mode, to “bake chicken nuggets” since the internal voice processing module can learn the appropriate temperature the user associates with baking of chicken nuggets.

The present application describes a built-in local learning mode of an internal voice processing module of an apparatus, which allows the user (or different users) to customize the voice control system, such as assigning wake words and prompts to the apparatus. The customization also allows the operation of multiple voice-controlled apparatus. As used herein the term “wake word” refers to a word or phrase to identify or name a device, causing the device to change state, e.g., from off to on. The wake word may also be used to switch an operating mode of the device. For example, the system can listen for a wake word to transition from an Idle state to an Awake state so that further voice commands can be processed.

Any user can personalize the wake word to replace or supplement the default wake word, or add or modify a prompt, thereby creating a customized experience, through entering the learning mode. Customization of the wake word can be achieved through at least two methods: a button-based method and a voice-command-based method. Customization of prompts can be achieved in either of these methods and occurs as described below for wake word modification.

In the button-based method (such as by a user contacting/pressing a button 104 of FIG. 1A), the user modifies the wake word by interacting with a button on the device. By holding the button for a designated period, such as five seconds, the system enters learning mode, at which point the user speaks the desired wake word. Once the new wake word is recorded, it is stored in memory of the voice processing module and becomes immediately active. The user can revert to the default wake word by holding the button for a longer duration, such as for ten seconds. After a new wake word is selected, or the wake word is reverted to default, the apparatus can operate as shown in FIG. 3.

In the voice-command-based method (such as by a user speaking into a microphone 102 of FIG. 1A), the user prompts the voice processing module to enter the learning mode by issuing a voice command such as “Change device name” or “Change your wake word.” In response, the voice processing module transitions into the learning mode and prompts the user to clearly state the desired wake word, which is then stored in memory of the voice processing module for future activations. This voice-command-based method, further discussed in reference to FIG. 6, provides a hands-free means for wake word customization. Local learning mode further enables users to operate multiple voice devices (for example both the apparatus 100 and the apparatus 200 and/or two of the apparatus 100 and/or two of the apparatus 200), each with a unique wake word. Local learning mode further enables multiple users to operate one or multiple voice devices (for example both the apparatus 100 and the apparatus 200 and/or two of the apparatus 100 and/or two of the apparatus 200), each with a unique wake word which is differentiable by each of the multiple users. For example, the device can learn that the voice input of User A for “cook chicken nuggets” means to operate the air fryer apparatus at 350° of 12 minutes, and that the voice input of User B for “cook chicken nuggets” means to operate the air fryer apparatus at 375° of 14 minutes. Unlike traditional systems where identical devices respond to the same commands, this system allows for unique wake words to differentiate between devices and between users, thereby improving flexibility and user convenience. After a new wake word is selected, or the wake word is reverted to default, the apparatus can operate as shown in FIG. 3.

Referring again to FIG. 4, in awake mode 410 the awake mode apparatus 400B can either return to idle mode 403 if after a predetermined period of time a command phrase is not received, or the awake mode apparatus 400B can enter active mode 420 and become active mode apparatus 400C if a command phrase is received within a predetermined period of time.

In active mode 420 the active mode apparatus 400C, together with the internal voice processing module, determines the behavior output associated with the inputted command phrase, and proceeds with that behavior, for example, activating heat elements, setting oven temperature to 375° and setting a timer for 12 minutes, to achieve the intent of the command phrase “cook chicken nuggets”. After the behavior is achieved, for example the food is cooked for the specified time at that temperature, the active mode apparatus 400C can return back to awake mode 410 and become awake mode apparatus 400B.

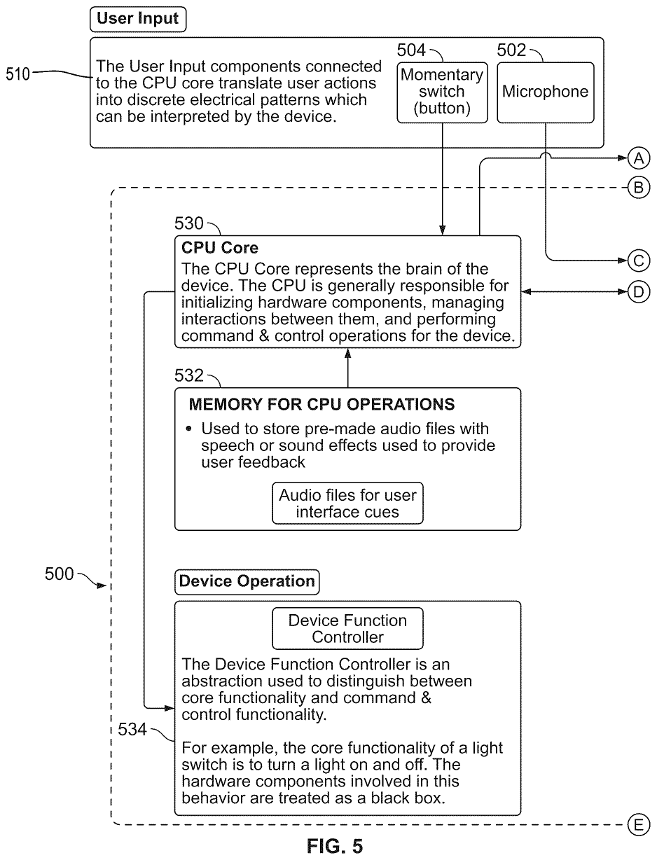

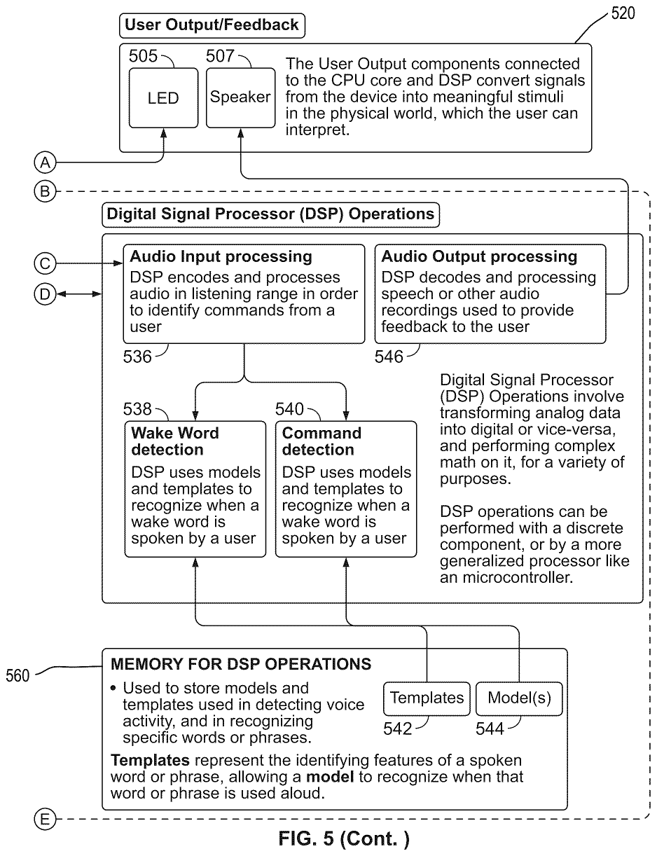

FIG. 5 is an illustration of functional blocks of an internal voice processing module 500 coupled with a user input section 510, a user output section 520. The user input section 510 includes a momentary switch 504 and a microphone 502. The user output section 520 includes a visual indicator such as an LED 505 and an acoustic output such as a speaker 507. The internal voice processing module 500 includes a central processing unit 530 configured to process signals from other components of the module 500, a signal processing unit 536 configured to process the signal from the microphone, a device function controller 534 configured to generate commands for controlling an electronic device, and a memory section 560 configured to store data used by the processing module 500.

The internal voice processing module 500 is configured to receive an input from a user, such as through a button 504 and/or a microphone 502. User input through either the button 504 or the microphone 502 includes a translation of that utterance into discrete electrical patterns that can be used by the internal voice processing module 500.

When an input is received through the button 504, the input is transmitted to a central processing unit (CPU) 530. As used herein, the term “CPU” and/or “processor” may refer to, is part of, or includes circuitry capable of sequentially and automatically carrying out a sequence of arithmetic or logical operations; recording, storing, and/or transferring digital data. As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality. The term “processor” may refer to one or more application processors, one or more baseband processors, a physical central processing unit (CPU), a general purpose processing unit (GPU), a single-core processor, a dual-core processor, a triple-core processor, a quad-core processor, and/or any other device capable of executing or otherwise operating computer-executable instructions, such as program code, software modules, and/or functional processes.

The input received through the button 504 is transmitted to the CPU 530, with the CPU 530 using that input to coordinate a response, such as the CPU 530 initializing one or more hardware components, managing interactions between components, and performing command and control operations for the apparatus the internal voice processing module 500 is contained in. In one embodiment, the CPU 530 switches a mode of the electronic device according to the signal from the button 504. For example, the CPU 530 can transmit a signal to a device function controller 534, which can be a separate controller and/or be a portion of the CPU 530 itself. The device function controller 534 can perform command and control functionality of the apparatus the internal voice processing module 500 is contained in, for example, the core functionality of a plug apparatus (such as the apparatus of FIG. 2) is to supply or restrict electricity flow to, for example a light, so that the light turns on and off.

The CPU 530 can also receive data from a memory 532. As used herein, the term memory includes integrated circuits that are composed primarily of memory (e.g. data storage, etc.) cells, such as DRAMs (Dynamic Random Access Memories), SRAMs (Static Random Access Memories), FeRAMs (Ferro-Electric RAMs), MRAMs (Magnetic Random Access Memories), Flash Memory and other forms of random access memory and related memories that store information using electrical, optical, magnetic, chemical, biological properties, combinations of these, or other means. Dynamic memory device types may include, but are not limited to, FPM DRAMs (Fast Page Mode Dynamic Random Access Memories), EDO (Extended Data Out) DRAMs, BEDO (Burst EDO) DRAMs, SDR (Single Data Rate) Synchronous DRAMs (SDRAMs), DDR (Double Data Rate) Synchronous DRAMs, DDR2, DDR3, DDR4, or any of the expected follow-on memory devices and related memory technologies such as Graphics RAMs (e.g. GDDR, etc.), Video RAMs, LP RAM (Low Power DRAMs) which may often be based on the fundamental functions, features and/or interfaces found on related DRAMs. Memory may include chips (e.g. die, integrated circuits, etc.) and/or single or multi-chip packages (MCPs) or multi-die packages (e.g. including package-on-package (PoP), etc.) of various types, assemblies, forms, and configurations. In multi-chip packages, the memory devices may be packaged with other device types (e.g. other memory devices, logic chips, CPUs, hubs, buffers, intermediate devices, analog devices, programmable devices, etc.) and may also include passive devices (e.g. resistors, capacitors, inductors, etc.). These multi-chip packages etc. may include cooling enhancements (e.g. an integrated heat sink, heat slug, fluids, gases, micromachined structures, micropipes, capillaries, etc.) that may be further attached to the carrier and/or another nearby carrier and/or other heat removal and/or cooling system.

In FIG. 5, memory 532 stores pre-made audio files with speech and/or sound effects to provide user feedback through a speaker 507, discussed herein. The CPU 530 can receive the stored file from the memory 532, and transmit a signal to the speaker 507. Additionally, the CPU 530 can transmit a signal to a notification screen and/or light, such as a light emitting diode (LED) 505. The signal transmitted to the, in this embodiment, the LED 505 can include different patterns and/or different colors of illumination based on the requested feedback.

When an input is received through the microphone 502, microphone 502 outputs an electrical signal to an audio input processor 536. This audio input processor 536 can be a digital signal processor that encodes and processes the electrical signal from the microphone to identify comments or commands from a user. The audio input processor 536 alone, or together with audio output processor 546 discussed further herein, involve transforming audio data received through the microphone 502 into a format suitable for voice recognition, and also perform complex mathematical operations.

The audio input processor 536 can process the audio for wake word detection, for example if the user has spoken the wake word, in wake word detection processor 538. Wake word detection processor 538 receives input from the DSP 356 and uses models and templates to recognize when a sound detected by the microphone 502 is a wake word spoken by a user.

The audio input processor 536 also outputs signals to a command detection processor 540 for command detection. For example if the user has spoken a command, such as “turn temperature to 375°”, the DSP outputs processed audio data to the command detection processor 540, which uses models and templates to recognize when a sound detected by the microphone 502 is a command spoken by a user.

Template(s) 542 and model(s) 544 are stored for use and/or access by both the wake word detection processor 538 and the command detection processor 540. Template(s) 542 and model(s) 544 are used and/or accessed to recognize specific words or phrases received through microphone 502 so that it can be determined if those words or phrases are a wake word or a command. Template(s) 542 represent the identifying features of a spoken word or phrase that allow model(s) 544 to recognize when that word or phrase is present in audio data. As used herein, the term model may refer to a combination of digital data and programming logic that embodies a computerized representation of logical and/or mathematical relationships between data elements. For example, a speech model usable by command detection processor 540 that indicates relationships between audio features in the user's speech and the device's commands. For example, a model can notify the audio input processor 536 and/or the CPU 530 how to recognize a particular semantic class (such as speaker or language) when the computer processes an audio stream. Classifier software may use any one or more of the following types of models: a machine learning model, a neural network, a deep neural network, one or more models trained to recognize at least two different languages, one or more models trained to recognize at least two different speakers.

To provide feedback to the user through the speaker 507 of the apparatus, the audio output processor 546 can decode and process audio recordings to provide auditory feedback to the user, such as causing the speaker 507 to emit the sound “air fryer is preheated”.

FIG. 6 illustrates a learning mode 600 of the internal voice processing module 500, such as the learning mode illustrated in FIG. 4, so that the internal voice processing module 500 can operate as (or can include a component that operates as) a learning module. In an embodiment, the learning mode S602 is configured to combine a new wake word or command into a new template. The learning mode S602 may be activated by an oral command such as “learning” or “new command.” The learning mode S602 may be automatically entered when the processing module 500 recognizes a new command or a new wake word. At step S602 the internal voice processing module enters learning mode to record a replacement wake word or a command. The internal voice processing module 500 processes the new recording and combines several results into a new template, such as template 542 of FIG. 5.

After entering learning mode at step S604 the internal voice processing module decides whether or not the memory, such as memory 532 of FIG. 5, contains three new templates. If at S604 three new templates are not in memory (S604: NO), the internal voice processing module proceeds to step S606 to record microphone input, such as microphone 502 of FIG. 5, to record audio input to a temporary portion of the memory. Then, the internal voice processing module proceeds to process the audio, such as through a feature extraction process in step S608. After S608 the internal voice processing module attempts to generate a new template from the processed audio in step S610. If step S610 is successful, such as if the template criteria have been met, at step S612 the internal voice processing module method proceeds to save the new template to the temporary memory at S614 and then proceed back to S604. If step S610 is unsuccessful, at step S612 the internal voice processing module method proceeds to directly back to S604.

If at S604 three new templates are in memory (S604: YES), then the internal voice processing module method proceeds to step S616 and the internal voice processing module combines the three templates using any suitable method. After combination the method proceeds to step S618 of saving the resultant table in memory and then cue the user that the saving action is complete in step S610. The cue in S610 can be through one or both of the screen and/or light (LED) 505 and the speaker 507 of the apparatus. The internal voice processing module then exits learning mode.

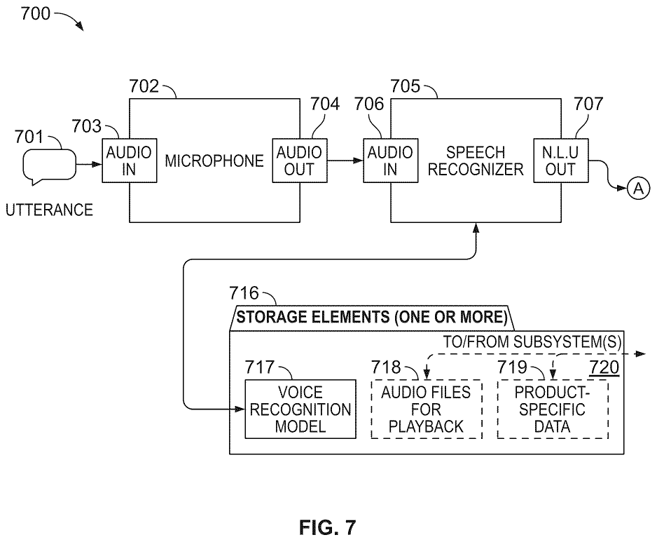

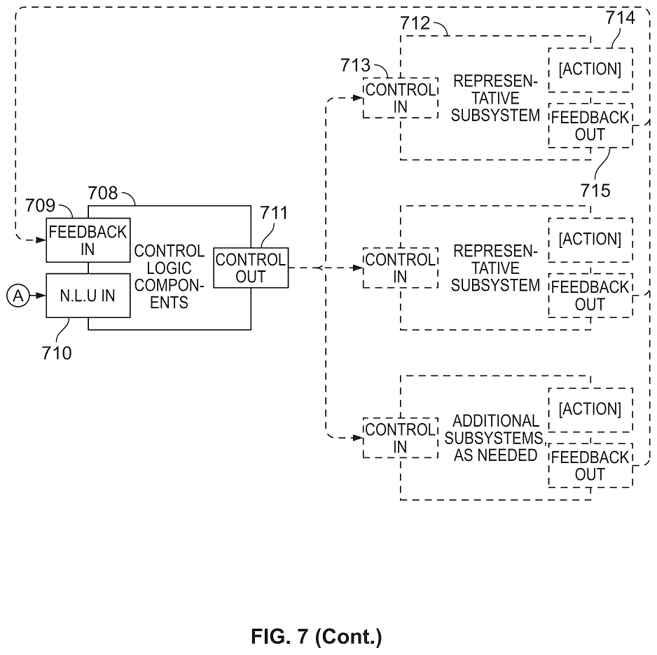

Another embodiment is shown in FIG. 7. FIG. 7 is an example of an architecture 700 of an air fryer. The embodiment of FIG. 7 is a local, non-networked voice-interactive air fryer that performs all speech capture, recognition, intent interpretation, dialogue policy, safety gating, and actuator control on the air fryer apparatus.

FIG. 7 presents the generalized, offline voice-control architecture. A user utterance 701 is received by a microphone 702 (such as microphone 102 of FIG. 1A and microphone 202 of FIG. 2) that receives audio in 703 and transmits audio out, as an electrical audio stream, at 704 to an audio in 706 of a speech recognizer 705. The speech recognizer 705, along with the remaining components of FIG. 7, is a portion of, or interacts with, the internal voice processing module (500 of FIG. 5). The speech recognizer 705 executes entirely on-apparatus (such as apparatus of FIGS. 1 and 2), consults one or more models and data stored on the storage block 716 (such as memory 532 of FIG. 5), recognizes the word uttered by the user 701, detects the intent of the user, and transmits structured natural-language understanding data (NLU) at NLU Out 707, In an embodiment, the transmitted structured natural-language understanding data includes encoded data indicating the detected intent of the utterance and any parameters.

A control-logic module 708 receives the parsed intent through NLU In 710 and concurrent telemetry on Feedback In 709, resolves the requested operation against current conditions and policy, and issues control signals on Control Out 711. Due to the concurrent telemetry configuration control-logic module 708 receives the same telemetry data or closely similar but different telemetry data from both NLU In 710 and Feedback In 709, or in a concurrent shared mode wherein some of the telemetry data is transmitted by the NLU In 710, and the rest of the telemetry data is transmitted by the Feedback In 709. Combined modes are also possible (for example certain data may be transmitted by both of the NLU In 710 and Feedback In 709 while other data is transmitted only by one of the NLU In 710 and Feedback In 709.

The concurrent telemetry includes status indicators from a plurality of representative subsystems, such as a power control system, a safety system, a temperature control system, an output system, and etc. For example, a first representative subsystem 712 receives Control In 713, performs its function and produces an action output 714, and may return a feedback output 715 to close the loop by reverting back through Feedback In 709. Additional subsystems, with two additional, optional subsystems shown vertically below the first representative subsystem 712 of FIG. 7 may be present as needed and follow the same control-in/action-out/feedback pattern as the first representative subsystem 712.

The storage block 716 may include an on-device voice-recognition model 717 (such as model 544 of FIG. 5), audio files for prompts or tones 718, and product-specific data such as recipe tables, default setpoints, and user-interface strings 719. Dashed links 720 indicate that stored audio or product data can be provided directly to subsystems—for example, audio files to a speaker path or text/parameters to a display—without leaving the local apparatus. Within this architecture the air fryer implements a four-state dialogue controller (Ready, Stage, Cooking, Door Open) and a safety manager; the speaker/button, display/LEDs, oven light, heaters, fan, door sensor, and buzzer are all subsystems addressed through Control Out 711 and monitored through Feedback In 709, so every utterance produces a deterministic, state-aware response entirely offline that is based on output of the control-logic module 708.

Operating on that framework, Dialogue Response Table (Table 1 below), in conjunction with control-logic module 708, defines how task commands and cookbook requests behave in each state, with the user command received as an utterance and the system response occurring without notification, or occurring through an auditory notification or display notification (such as notification screen and/or light, such as a light emitting diode (LED) 505 of FIG. 5).

TABLE 1

| Device | | |
|---|---|---|
| State | User Command | System Response |
| Ready | Increase the timer by 5 | Timer increased by 5 minutes |
| | minutes | |
| Stage | 12 minutes decrease the | Timer decreased by 12 minutes |
| | air fryer timer | |
| Cooking | Set the temperature to | Setting temperature to 350 |
| | 350 degrees | degrees. |
| Door | Decrease the temperature | Please close the door first |
| Open | by 30 degrees | |
| Ready | Cook chicken nuggets | Cooking chicken nuggets at 400 |
| | | degrees for 12 minutes. Say start |
| | | cooking to begin |
| Stage | Cook steak at 400 | Cooking steak at 400 degrees |
| | degrees for 5 minutes | for 5 minutes. Say start cooking |
| | | to begin |
| Cooking | Cook Broccoli | Cooking now. Cancel before |
| | | changing. |
| Door | Cook Crab | Please close the door first |
| Open | | |
| Ready | Cook tender chicken | Cooking chicken nuggets at 400 |
| | nuggets | degrees for 12 minutes. Say start |
| | | cooking to begin |
| Stage | Cook crispy chicken | Cooking chicken nuggets at 400 |
| | nuggets | degrees for 12 minutes. Say start |
| | | cooking to begin |
| Cooking | Cook tender chicken | Cooking now. Cancel before |
| | nuggets | changing. |
| Door | Cook crispy chicken | Please close the door first |
| Open | nuggets | |

Time/temperature edits are state-conditioned (Device State column of Table 1) in conjunction with control-logic module 708 and occur in Active mode (such as modes 320 and 420 of FIGS. 3 and 4, respectively): in Ready, a request to increase the timer by 5 minutes results in the apparatus emitting from a speaker-Timer increased by 5 minutes; in Stage, a request to reduce the timer by 12 minutes returns Timer decreased by 12 minutes; in Cooking, a request to set the temperature to 350 degrees responds Setting temperature to 350 degrees and adjusts the live setpoint; and with the Door Open state active, any such change (e.g., decrease the temperature by 30 degrees) is refused with Please close the door first audio message and/or display message. Cookbook invocations (such as cookbook invocation responses saved in the storage element 716) are staged with explicit start-gating: in Ready, cook chicken nuggets stages 400 degrees for 12 minutes and adds the instruction Say start cooking to begin; in Stage, a parameterized request such as cook steak at 400 degrees for 5 minutes updates the staged program and repeats Say start cooking to begin; while in Cooking, an attempt to change to another recipe such as cook broccoli is blocked with Cooking now. Cancel before changing; with Door Open, requests such as cook crab are refused with Please close the door first. Taste-modifier recipes apply deterministic offsets before staging: in Ready, cook tender chicken nuggets yields 400 degrees for 12 minutes with the same start instruction, and in Stage, cook crispy chicken nuggets yields 400 degrees for 12 minutes with the same start instruction; while Cooking, attempts to swap recipes return Cooking now. Cancel before changing, and with Door Open the responses uniformly instruct the user to close the door first. Table 1 therefore captures both staging versus execution separation and the door-open gate for any heat-affecting command.

A Safety Response Table(Table 2 below) enforces interlocks and safe stops in conjunction with control-logic module 708.

TABLE 2

| Device | | |
|---|---|---|
| State | User Command | System Response |
| Door Open | Turn on the light | The light is on |
| Door Open | Cook Mozzarella | Please close the door first |
| | Sticks | |
| Door Open | What is the air fryer | Door is open. The remaining time |
| | status | is x hrs/mins. The temperature |
| | | is x degrees. |
| Door Open | Decrease the volume | The volume is down. |
| Cooking | (user opens the door) | Door is open, be careful, it's hot. |
| Stage | Cancel cooking | Cooking has stopped |
| Cooking | Stop cooking | Cooking has stopped |

When the door is open, non-heating requests are allowed—turn on the light results in the light is on—while any request that would start or modify a cook, such as cook mozzarella sticks, is refused with Please close the door first. If the user asks for status with the door open, the device reports Door is open, the remaining time as x hours/minutes, and the current temperature as x degrees. Volume adjustments remain available even with the door open (e.g., decrease the volume returns The volume is down). If the door is opened during Cooking, the architecture 700 of the apparatus announces Door is open, be careful, it's hot. Cancellation commands are honored promptly and state-appropriately: in Stage, cancel cooking clears the pending program and returns Cooking has stopped; in Cooking, stop cooking terminates the active cycle and returns the same confirmation. These responses are generated and enforced by the control logic 708 using Feedback In 709 from door and cycle sensors, so dialogue-level safety activates before any hardware limit trips.

A Feedback Response Table (Table 3 below) provides confirmations and meta-controls that are available across states in conjunction with control-logic module 708.

TABLE 3

| Device | | |
|---|---|---|
| State | User Command | System Response |
| Stage | Cook chicken nuggets | Cooking chicken nuggets at 400 |
| | | degrees for 12 minutes. Say start |
| | | cooking to begin |
| Ready | (Second time the air | one beep sound |
| | fryer cannot recognize | |
| | the command) | |
| Any | Decrease the volume | The volume is down |
| | (Not minimum volume | |
| | after decrease) | |
| Any | Decrease the volume | The volume is down, lowest |
| | (Minimum volume after | volume reached |
| | decrease) | |
| Any | Increase the volume | The volume is up |
| | (Not maximum volume | |
| | after increase) | |
| Any | Increase the volume | The volume is up, maximum |
| | (Maximum volume after | volume reached |
| | increase) | |
| Any | Voice control on | Voice control is on |
| Any | Voice control off | Voice control is off, until you say |
| | | ‘voice control on’ |
| Stage | Flip reminder on | Flip reminder is on |
| Stage | Flip reminder off | Flip reminder is off |
| Cooking | (Cooking is finished) | Cook complete, be careful, it's hot. |
| Ready | What is the air fryer | I'm not cooking right now. The |
| | status | time is currently set to x hrs/mins. |
| | | The temperature is x degrees. |
| Stage | That is the temperature | The temperature is x degrees. |
| Cooking | How many time left | The remaining time is x hrs/mins. |
| Door | What is the air fryer | Door is open. The remaining time |
| Open | status | is x hrs/mins. The temperature is x |
| | | degrees. |

During Stage, a normal recipe request such as chicken nuggets elicits the parameterized confirmation Cooking chicken nuggets at 400 degrees for 13 minutes. Say start cooking to begin. Recognition robustness includes a single-beep policy after the second consecutive unrecognized command in Ready. Volume changes are available in any state and are boundary-aware: decreasing volume returns The volume is down, and if the minimum is reached the message is The volume is down, lowest volume reached; increasing volume returns The volume is up, and if the maximum is reached the message is The volume is up, maximum volume reached. Voice control toggles globally; voice control on produces Voice control is on, and voice control off produces Voice control is off, until you say voice control on, after which the unit ignores speech until re-enabled. A flip reminder can be enabled or disabled during Stage, with Flip reminder is on or Flip reminder is off confirming the choice; when enabled, the device schedules an in-cycle reminder. At the end of Cooking, the completion prompt is Cook complete, be careful, it's hot. Status queries are state-aware: in Ready the unit reports I'm not cooking right now, the time is currently set to x hours/minutes, and the temperature is x degrees; in Stage the apparatus reports The temperature is x degrees; in Cooking the apparatus reports The remaining time is x hours/minutes; and with the Door Open state active the apparatus reports Door is open together with remaining time and current temperature. All messages are produced locally from timers, setpoints, and sensors, using audio assets 718 and/or product data 719 accessed through the storage elements 716.

Taken together, FIG. 7 describes the offline microphone-to-recognizer-to-NLU-to-control pipeline and the closed-loop linkage to appliance subsystems; Table 1 sets the deterministic dialogue for time/temperature edits and recipe staging with tender/crispy modifiers and door-open gating; Table 2 establishes the priority of safety behaviors for door-open, cancel, and stop events; and Table 3 provides the meta-control and user-feedback layer, including beep signaling, global voice-control toggling, volume boundary confirmations, flip-reminder scheduling, completion prompts, and comprehensive, state-specific status replies. The result is a voice-interactive air fryer that operates entirely on-device, separates staging from execution, blocks unsafe transitions, and communicates every action and constraint clearly through local speech and indicators.

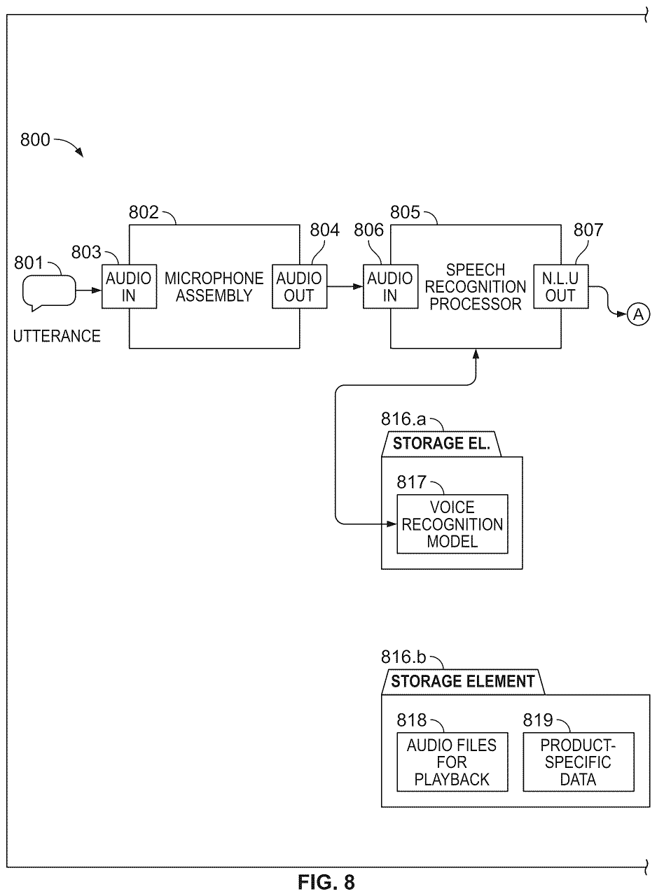

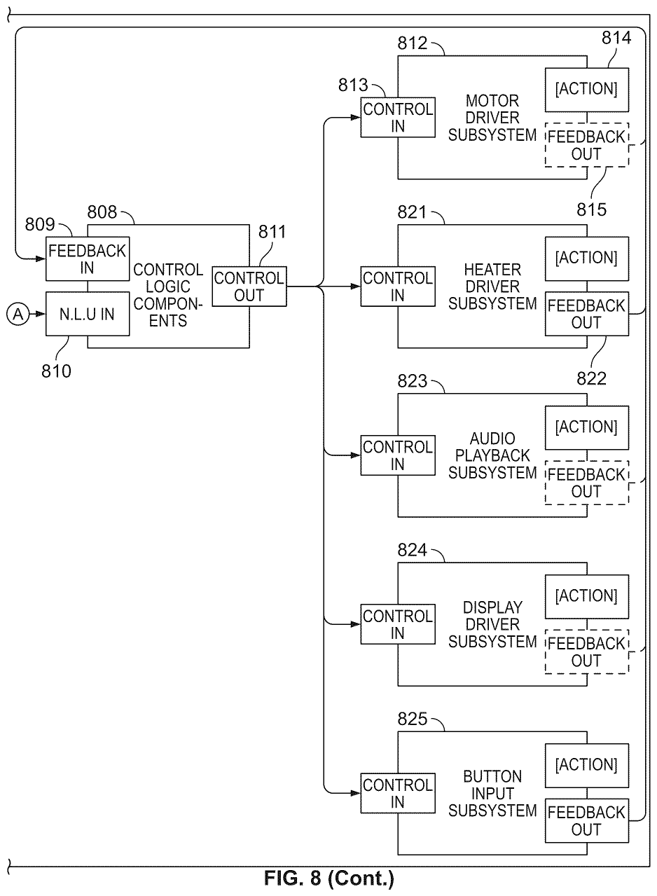

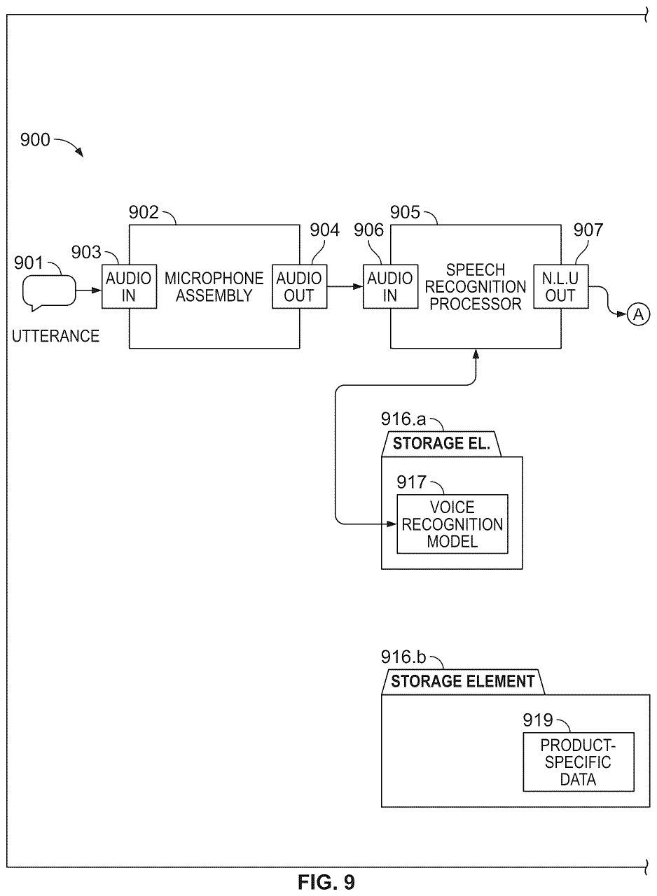

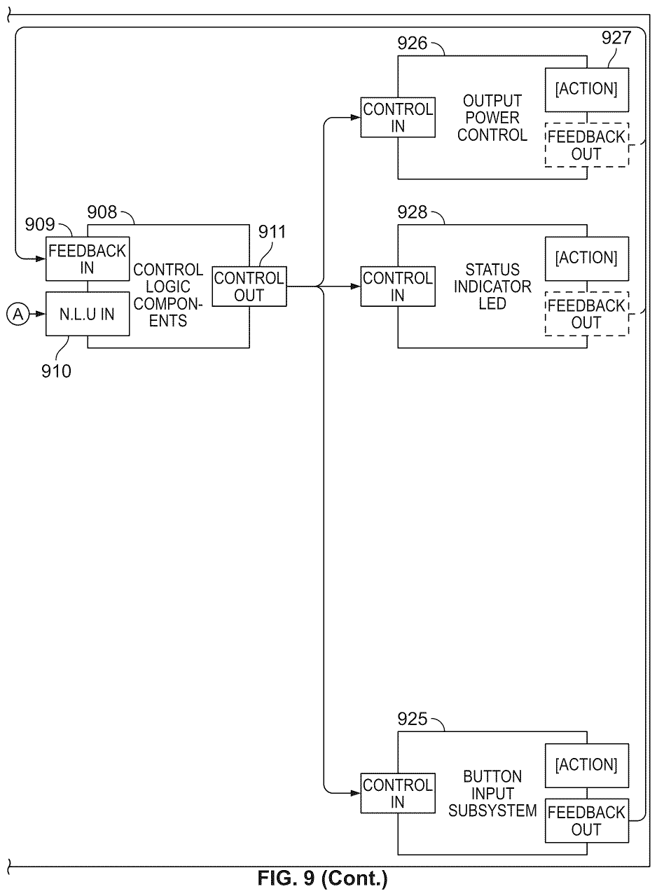

FIG. 8 illustrates another embodiment of architecture 800, that could be used for an air fryer (such as air fryer apparatus 100 of FIG. 1A), or any other suitable apparatus. Architecture 800 is similar or the same to architecture 700, with architecture 700 being generally applicable to suitable devices and architecture 800 being applied for air fryer apparatus. It should be understood that the functional components illustrated may be implemented within or in conjunction with internal voice processing module (500 of FIG. 5) and/or on another single printed circuit board, on multiple boards, or as separate modules in communication with each other, depending on design requirements. The connections shown are logical pathways, which may be realized using direct traces on a board, inter-board connectors, or standard communication buses such as a universal asynchronous receiver-transmitter (UART), inter-integrated circuit (PC), and a serial peripheral interface (SPI). Additionally, functional equivalents among FIGS. 7-9 can be considered equivalent, for example, the microphone 702 of FIG. 7 can be functionally equivalent to microphone 802 of FIG. 8 and microphone 902 of FIG. 9.

An utterance 801 is received by a microphone 802, which may be an analog microphone with preamplifier and analog-to-digital conversion or a digital microphone. The microphone 802 accepts an acoustic input 803 and provides an audio output 804 suitable for downstream speech recognition.

Audio output 804 is provided to a speech recognition processor 805. The speech recognition processor receives audio input 806, applies a stored recognition model 817, and produces structured natural-language output 807. The processor may be implemented by a microcontroller, a digital signal processor, a system-on-chip, or other processing circuitry configured for speech recognition, such as internal voice processing module 500. In some embodiments, the speech recognition processor may be located on the same circuit board as other components, while in other embodiments it may be located on a separate module in communication with the rest of the system.

The speech recognition processor 805 applies a voice recognition model 817, such as with internal voice processing module 500, stored within storage elements 816.a. The storage elements 816.a may include non-volatile memory or other storage media, and in this embodiment are used to retain a recognition model 817, as discussed herein, accessed by the processor 805. Multiple storage elements may be used, for example the two shown in FIG. 8, with one dedicated to the recognition model (816.a) and others dedicated to additional resources (such as 816.b). The processor produces structured natural-language output 807 representing the interpreted command.

The structured natural-language output 807 is provided to control logic components 808. The control logic can have two inputs and one output. The inputs include the NLU input 810 from the speech recognition processor 805 and a feedback input 809 from downstream subsystems. The output is a control signal 811 that directs the operation of subsystem components. The control logic 808 may be realized by processing circuitry configured to interpret the user's intent and translate it into device-specific commands. In various embodiments, the control logic may be integrated with the speech recognition processor or implemented as a separate processor on the same or different board.

Storage elements 816.b can also retain audio playback files 818 and apparatus-specific data 819. These resources are accessed by processing circuitry, such as the speech recognition processor 805 or the control logic 808, and provided to subsystems as needed to perform their functions. Subsystem 812, a motor driver subsystem, can include circuitry to drive one or more motors, such as a fan motor. Subsystem 812 can cause the motor to rotate throughout action 814 and provide feedback 815 that the motor is rotating. Subsystem 821, a heater driver subsystem, can include circuitry to cause a heat element to produce less or more heat. Subsystem 821 can cause the heat element to produce less or more heat through action 815 and provide feedback 822 of temperature. Subsystem 823, an audio playback subsystem, may include circuitry configured to generate audible signals through a transducer such as a speaker, without limitation to a particular type of audio output device. For example, audio playback files 818 may be retrieved and delivered to an audio playback subsystem 823, and product-specific data 819 may be retrieved and formatted for output by a display driver subsystem 824. The architecture does not require subsystems to access memory directly; rather, resources are made available through the processing components as appropriate for implementation.

FIG. 9 illustrates an embodiment of the localized voice-control system architecture 900 as applied to a voice-controlled electrical plug (such as plug apparatus 200 of FIG. 2). Architecture 900 is similar or the same to architecture 700, with architecture 700 being generally applicable to suitable devices and architecture 900 being applied for plug apparatus. Elements identified with the same reference numerals as in the generic and air-fryer embodiments represent corresponding components performing the same or similar functions; the description below focuses on their operation within this embodiment.

A user utterance 901 is received by a microphone 902 which accepts acoustic input 903 and provides an electrical audio output 904. The audio output is delivered to a speech-recognition processor 905 through an audio-input 906. The speech-recognition processor 905, along with the remaining components of FIG. 9, is a portion of, or interacts with, the internal voice processing module (500 of FIG. 5).

The processor executes a stored on-device voice-recognition model 917 contained within a storage element 916.a and produces structured natural-language understanding (NLU) data at output 907. The control-logic components 908 receive the parsed intent on NLU input 910 together with any feedback signals 909 returned from subsystems, evaluate system state and command validity, and issue control signals through control output 911. Additional storage 916.b retains product-specific data 919 used by the control logic to interpret commands and manage device behavior.

The control-output signals 911 are distributed to a set of subsystems appropriate to the plug embodiment. An Output Power Control subsystem 926 receives control input and performs the commanded switching of electrical continuity to the plug outlet. In response to a valid on/off command, the subsystem executes its action 927 by energizing or de-energizing the connected load. The optional feedback connection shown in dashed lines indicates that no feedback signal is provided in this embodiment, although such a path may exist in others.

A Status Indicator LED subsystem 928 receives control signals from the control logic to present visual indications of device state, such as power-on, listening, or processing. The LED provides a simple visual feedback mechanism and does not return feedback to the control logic in this embodiment.

A Button Input Subsystem 925 detects actuation of a button on the plug housing. Upon detecting an actuation, the subsystem generates a signal to the control logic indicating a user request to toggle output power, functioning in parallel with voice-command control.

The overall system processes all speech locally on the device without reliance on external servers or network connectivity. The plug embodiment thus implements the same local voice-control architecture (such as architecture 700 and/or architecture 900) adapted for a power-control device, where voice or manual inputs are interpreted by the on-device processor to control output power and to provide user feedback through a status indicator.

In FIG. 9 and the corresponding behavioral Table 4, the embodiment described herein relates to a localized voice-control system applied to a voice-recognized electrical plug. The plug implements on-device speech recognition, command mapping, timing control, and visual feedback without reliance on any external network or mobile application.

TABLE 4

| Device | | Command | |
|---|---|---|---|
| State | Function | Phrase | Behavior Detail |
| Ready | Power, on | Turn on | Power [on/off]; |
| | | | flash indicator LED for 2 sec; |
| Ready | Power, on | Power on | Power [on/off]; |
| | | | flash indicator LED for 2 sec; |
| Ready | Power, on | Power up | Power [on/off]; |
| | | | flash indicator LED for 2 sec; |
| Ready | Power, on | Lights on | Power [on/off]; |
| | | | flash indicator LED for 2 sec; |
| Ready | Power, off | Turn off | Power [on/off]; |
| | | | flash indicator LED for 2 sec; |
| Ready | Power, off | Power off | Power [on/off]; |
| | | | flash indicator LED for 2 sec; |
| Ready | Power, off | Power down | Power [on/off]; |
| | | | flash indicator LED for 2 sec; |
| Ready | Power, off | Lights off | Power [on/off]; |
| | | | flash indicator LED for 2 sec; |
| Ready | Timer, delayed- | Wake in | flash indicator LED for 2 sec; |
| | start, set value | [15/30/45] | wait X; |
| | | minutes | if power = off, set power = |
| | | | on; |
| Ready | Timer, delayed- | Wake in | flash indicator LED for 2 sec; |
| | start, set value | [1/2/4/8/12] | wait X; |
| | | hour(s) | if power = off, set power = |
| | | | on; |
| Ready | Timer, delayed- | Set timer for | flash indicator LED for 2 sec; |
| | stop, set value | [15/30/45] | wait X; |
| | | minutes | if power = on, set power = |
| | | | off; |
| Ready | Timer, delayed- | Set timer for | flash indicator LED for 2 sec; |
| | stop, set value | [1/2/4/8/12] | wait X; |
| | | hour(s) | if power = on, set power = |
| | | | off; |
| Ready | Timer, delayed- | Sleep in | flash indicator LED for 2 sec; |
| | stop, set value | [15/30/45] | wait X; |
| | | minutes | if power = on, set power = |
| | | | off; |
| Ready | Times, delayed- | Sleep in | flash indicator LED for 2 sec; |
| | stop, set value | [1/2/4/8/12] | wait X; |
| | | hour(s) | if power = on, set power = |
| | | | off; |
| Ready | Timer, delayed- | Cancel wake | flash indicator LED for 2 sec; |
| | start, cancel | | if delayed-start is set, unset it; |
| Ready | Timer, delayed- | Cancel sleep | flash indicator LED for 2 sec; |
| | stop, cancel | | if delayed-stop is set, unset it; |
| Ready | Timer, delayed- | Cancel timer | flash indicator LED for 2 sec; |
| | stop, cancel | | if delayed-stop is set, unset it; |

When the plug is in a Ready state (Device State Column of Table 4), the system continuously monitors for user utterances 901. The microphone 902 receives acoustic input 903 and delivers the electrical audio signal 904 to the speech-recognition processor 905 executing an embedded voice-recognition model. The speech-recognition processor 905 generates structured natural-language understanding data, which the control-logic components interpret in accordance with stored product-specific data. The control logic 908 evaluates the current operating condition—such as whether the plug output is energized or idle—and determines the appropriate response to each recognized command.

Power-related commands include all forms of activation and deactivation phrases, encompassing expressions equivalent to “Turn on,” “Power on,” “Power up,” or “Lights on,” as well as their off-state counterparts such as “Turn off,” “Power off,” “Power down,” or “Lights off.” Upon recognition of a valid power-on command, the control logic 908 signals the Output Power Control 926 subsystem to energize the connected outlet, simultaneously instructing the indicator LED 928 to flash for approximately two seconds as acknowledgment. Likewise, a power-off command causes the relay to de-energize the outlet and the LED to flash for the same duration, providing the user with consistent, immediate visual confirmation of the executed action.

The system also supports time-based automation through delayed-start and delayed-stop functions, enabling the user to schedule activation or deactivation by voice. When a delayed-start command is detected—for example, “Wake in 15 minutes,” “Wake in 30 minutes,” or “Wake in 1, 2, 4, 8, or 12 hours”—the plug flashes the indicator LED for two seconds to confirm command acceptance, records the specified time interval, and initiates an internal countdown. Upon expiration of the countdown, the control logic 908 checks the stored power state; if the plug is off, it automatically activates the power output. This permits a connected appliance or lamp to be energized after a selected delay period without additional user intervention.

Conversely, delayed-stop commands such as “Set timer for 15 minutes,” “Set timer for 1 hour,” “Sleep in 30 minutes,” or “Sleep in 2 hours” initiate a countdown toward power deactivation. The LED again flashes for two seconds to acknowledge receipt, and the system maintains power until the designated time elapses, at which point the control logic 908 transmits an off signal to the Output Power Control subsystem, terminating electrical continuity to the load. This enables voice-scheduled power-off operations for energy saving or convenience.

In addition to setting timers, the system can cancel any active delayed-start or delayed-stop operation. When the user issues a cancellation command such as “Cancel wake,” “Cancel sleep,” or “Cancel timer,” the plug flashes the indicator LED for two seconds to indicate successful recognition and clears any active timing flags from memory. Once canceled, no automatic power change will occur.

All behaviors described are executed by the on-device control logic 908 and subsystems. Each recognized command produces a deterministic response pattern that combines electrical action and LED feedback. The plug thus provides intuitive, hands-free control over both immediate and scheduled power delivery, while maintaining full functionality in offline environments.

This embodiment demonstrates a compact implementation of localized voice control for power devices, in which speech-recognition architecture (such as architecture 700 and/or architecture 900) is adapted for an electrical plug form factor. The integration of multi-phrase recognition, delayed-action logic, and consistent visual feedback ensures operational reliability and user confidence without dependence on external connectivity.

The described embodiments and examples of the present disclosure are intended to be illustrative rather than restrictive and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and, in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure.

Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1. An air fryer apparatus configured for cooking food, the air fryer apparatus comprising:
an internal cavity within a body of the air fryer apparatus;
a heating element configured to generate heat within the internal cavity;
a perforated frame configured to fit within the internal cavity and configured to support a food product;
a fan configured to move heat from the heating element toward the food product;
a microphone for receiving a voice input;
a voice processing module configured to determine a command for controlling the air fryer apparatus based on the voice input, the voice processing module including a localized module that processes the voice input locally; and
a memory storing a plurality of commands for controlling the air fryer apparatus.

2. The air fryer apparatus of claim 1, further comprising a button configured to accept an identification of the air fryer apparatus.

3. The air fryer apparatus of claim 2, wherein the button is configured to accept a wake word of the air fryer apparatus.

4. The air fryer apparatus of claim 1, wherein the air fryer apparatus includes no function to connect to a network.

5. The air fryer apparatus of claim 1, wherein the voice processing module is configured to allow a user to customize a wake word.

6. The air fryer apparatus of claim 5, wherein the voice processing module is configured to switch an operating state of the air fryer apparatus from an Idle state to an Awake state when the wake word is identified.

7. The air fryer apparatus of claim 1, wherein the voice processing module is configured to assign a wake word to the air fryer apparatus based on the voice input.

8. The air fryer apparatus of claim 1, wherein the localized module further comprises a learning module configured to learn voice inputs of different users.

9. The air fryer apparatus of claim 8, wherein the learning module is configured to learn the voice inputs of different users locally.

10. The air fryer apparatus of claim 1, further comprising a feedback interface configured to provide feedback to a user.

11. The air fryer apparatus of claim 10, wherein the feedback interface emits an optical signal indicating a status of the voice processing module.

12. The air fryer apparatus of claim 10, wherein the feedback interface generates an acoustic signal indicating a status of the voice processing module.

13. A hardware processor for an apparatus comprising:
a central processing unit configured to receive a first input from a user;
an audio input processor configured to receive a second input, wherein the second input is a voice input, the audio input processor further configured to process the second input locally, and transmit the processed second input to a command detection processor;
the command detection processor to locally identify a command from the processed second input; and
a learning module configured to locally learn voice inputs of different users.

14. The hardware processor of claim 13, wherein the first input includes a signal generated by a button.

15. The hardware processor of claim 14, wherein the button is configured to identify the apparatus.

16. The hardware processor of claim 13, wherein the hardware processor includes no function to connect to a network.

17. The hardware processor of claim 13, further comprising a wake word detection processor configured to detect a wake word, wherein the hardware processor is configured to switch a state of the apparatus from an idle state to an awake state when the wake word is detected.

18. A method of controlling an apparatus, the method comprising:
receiving an acoustic input via a microphone;
transmitting the acoustic input to an acoustic input processor configured to locally determine a command for controlling the apparatus based on the acoustic input;
storing a plurality of commands for controlling the apparatus;
determining the command from the plurality of commands; and
locally learning acoustic inputs of different users.

19. The method of claim 18, further comprising:
activating an identifying function via a button of the apparatus, wherein the button allows a user to name the apparatus.

20. The method of claim 18, further comprising:
detecting a wake word from the acoustic input, wherein the wake word cause the apparatus to switch from an idle state to an awake state.
